(19) United States
(12) Patent Application Publication
(10) Pub. No.: US 2025/0315561 A1
(43) Pub. Date: Oct. 9, 2025

(54) METHOD FOR DISPLAYING PIPE CONDUCTANCE IN VACUUM SYSTEM AND APPARATUS THEREFOR

(71) Applicant: Tae Ook KANG, Asan-si (KR)

(72) Inventor: Tae Ook KANG, Asan-si (KR)

(21) Appl. No.: 18/714,716

(22) PCT Filed: Dec. 3, 2021
(86) PCT No.: PCT/KR2021/018205

§ 371 Date: Nov. 6, 2024

(30) Foreign Application Priority Data
Dec. 3, 2021 (KR) 10-2021-0171458

(51) Int. Cl. G06F 30/12; G06F 30/18; G06F 113/14

(52) U.S. Cl. CPC G06F 30/12; G06F 30/18; G06F 2113/14

(57) ABSTRACT

Provided is a method of displaying pipe conductance in a vacuum system including at least one chamber, pipe, and pump, the method being implemented in a vacuum system design program of a server, according to an embodiment of the present invention, and comprising the steps of: (a) according to a user input, setting specifications and process conditions of a chamber, a pipe, and a pump of a first vacuum system disposed in a virtual region; (b) displaying the first vacuum system on a screen on the basis of the specifications and process conditions of the chamber, pipe, and pump; (c) calculating a conductance value of the entire pipe according to a certain pressure value among the process conditions and displaying the calculated conductance value on the screen where the first vacuum system is implemented; and (d) displaying the conductance value of each component of the pipe, preset according to the specific pressure value, as a color temperature through direct display or relative comparison according to a user setting.

### TECHNICAL FIELD

The present disclosure relates to a method of displaying pipe conductance in a vacuum system and an apparatus therefor, and more particularly, to a method of displaying pipe conductance depending on process pressure changes when designing a vacuum system and an apparatus therefor.

### BACKGROUND ART

Vacuum technology is technology that creates a vacuum in a chamber (container) and allows various experiments or production therein. Vacuum technology does not create anything in itself, but is basic technology that provides the foundation of research or manufacturing. Here, the vacuum refers to a state in which a gas pressure in a space is lower than atmospheric pressure.

A vacuum system including a chamber, piping, and a pump creates a vacuum state necessary for manufacturing or research within the chamber, so as to allow smooth process progress. The vacuum prevents reaction or oxidation caused by influence of other gases, lowers the boiling point of materials, cleans surfaces, removes residual gases, and makes it easy to add desired materials.

Vacuum systems which provide the above effects are applied to all industrial fields, especially large-scale basic industries, such as semiconductors and displays.

However, most vacuum systems used in the field have inefficiencies due to low conductance piping configurations, such as use of unnecessarily large capacity pumps or use of excessively curved pipes, narrow pipes, and reduced pipes.

Accordingly, there is a need for measures to select piping and a pump with optimal specifications which satisfy process conditions set by a user through a vacuum system simulation when designing a vacuum system.

Particularly, in the case of piping, a pipe conductance value changes depending on pressure changes and pipe conductance may be confirmed through such a pipe conductance value change, but there is no method of improving and optimizing pipe specifications based on specific system implementation environment or comparison results to compare these changes.

In addition, there is a need to display a pipe conductance value as a color temperature on a vacuum system screen visually implemented in the program so that inefficient sections may be visually easily checked, so as to allow a manager to facilitate pipe improvement and optimization through a design program.

### DISCLOSURE

### Technical Problem

Therefore, the present invention has been made in view of the above problems, and it is an object of the present invention to provide a method which designs a vacuum system through visual modeling, calculates conductance values of respective pipes so as to confirm inefficient pipes on a screen where the system is implemented, displays the conductance values as different color temperatures so as to evaluate efficiency depending on each conductance value, and improves conductances of pipes to be improved through the vacuum system implementation screen on which the conductance values of the respective pipes are displayed as the different color temperatures.

### Technical Solution

In accordance with one aspect of the present disclosure, the above and other objects can be accomplished by the provision of a method of displaying pipe conductance in a vacuum system including at least one chamber, piping, and pump, implemented in a vacuum system design program of a server, the method including steps of (a) setting specifications of a chamber, piping, and a pump, and process conditions of a first vacuum system disposed in a virtual area, depending on user input, (b) displaying the first vacuum system on a screen based on the specifications of the chamber, the piping, and the pump, and the process conditions, (c) calculating a total conductance value of the piping depending on a specific pressure value among the process conditions and displaying the calculated total conductance value on the screen where the first vacuum system is implemented; and (d) displaying conductance values of respective piping components, preset depending on the specific pressure value, as color temperatures through direct display or relative comparison depending user settings.

The method may further include a step of (e) based on the first vacuum system designed to have specifications before pipe improvement and a second vacuum system designed to have specifications after pipe improvement, displaying, by the server, total conductance values of respective pipings of the first and second vacuum systems and color temperatures corresponding to conductance values of respective piping components of the first and second vacuum systems on a screen so as to be compared with each other.

In the step of (e), results of the first and second vacuum systems including numerical display of the total conductance values of the pipings of the respective systems depending on the specific pressure value, and pipe efficiency evaluation results indicating the conductance values of all of the piping components used in the first and second vacuum systems as the color temperatures may be displayed on one screen.

If there is a plurality of piping components, color temperatures of at least two piping components may be displayed differently through direct display or relative comparison by user settings depending on the conductance values of the respective piping components of the piping of the vacuum system under a specific pressure, and thereby, pipe efficiencies may be indicated depending on the color temperatures.

When an interface is positioned on each of the piping components of the vacuum system by user action, a guide tip configured to improve conductance of a corresponding one of the piping components may be provided.

The guide tip may guide replacement of the corresponding one of the piping components where a cursor is positioned to improve the conductance of the corresponding one of the piping components, or may provide guidance on changing specification details, including changing an angle or inner diameter of the corresponding one of the piping components.

The server may repeat the steps depending on user input until optimal specifications of the plurality of piping components are efficiently selected within a range within which the vacuum system designed by a user satisfies both first process conditions and second process conditions.

In accordance with another one aspect of the present disclosure, there is provided a computer-readable medium including instructions for performing the method.

In accordance with yet another one aspect of the present disclosure, there is an apparatus for displaying pipe conductance in a vacuum system including at least one chamber, piping, and a pump, implemented in a vacuum system design program of a server, the apparatus including at least one processor, and a memory connected to the at least one processor, wherein the memory stores program instructions executable by the at least one processor to set specifications of a chamber, piping, and a pump, and process conditions of a first vacuum system disposed in a virtual area, depending on user input, to implement the first vacuum system on a screen based on the specifications of the chamber, the piping, and the pump, and the process conditions, to calculate a total conductance value of the piping depending on a specific pressure value among the process conditions and displaying the calculated total conductance value on the screen where the first vacuum system is implemented, and to display conductance values of respective piping components, preset depending on the specific pressure value, as color temperatures through direct display or relative comparison depending user settings.

### Advantageous Effects

A method and apparatus for displaying pipe conductance in a vacuum system according to the present disclosure may display pipe conductance values changed depending on a specific pressure change in piping design on a vacuum design system, may confirm detailed conductances of pipes calculated under a specific pressure through color temperatures by relative comparison together with quantitative values, and may thereby confirm the conductances of pipes requiring improvement, thereby being capable of optimizing the specifications and conductances of the pipes requiring improvement through pipe replacement, etc.

Further, by simultaneously performing pipe conductance evaluation of a plurality of systems before and after improvement under an arbitrarily input pressure (a main process pressure, i.e., the same pressure), color temperature changes of the respective pipes of the piping may be confirmed, and how much the total conductance of the piping has improved may be quantitatively compared and confirmed through the total pipe conductance value Cₜₒₜₐₗ at the corresponding pressure.

In addition, the conductance values of the respective pipes are displayed as the color temperatures to be visually confirmed so that a manager may easily optimize the piping through a design program, thereby allowing a user to easily confirm non-conductance sections and thus increasing user convenience.

### DESCRIPTION OF DRAWINGS

FIG. 1 is a block diagram for providing vacuum system design according to one embodiment of the present disclosure;

FIG. 2 is a flowchart showing a process of displaying and improving pipe conductances when designing a vacuum system according to one embodiment of the present disclosure;

FIG. 3 is a diagram showing simulation results before and after pipe improvement according to one embodiment of the present disclosure.

FIG. 4 is a diagram illustrating an algorithm for calculating conductance depending on each pipe shape at each pressure according to one embodiment of the present disclosure.

### MODE FOR INVENTION

Hereinafter, exemplary embodiments of the present disclosure will be described in detail with reference to the accompanying drawings. However, the spirit of the present disclosure is not limited to the embodiments, and those skilled in the art who understand the spirit of the present disclosure may easily propose other regressive inventions or other embodiments included within the scope of the invention through addition of other elements, change, or deletion within the scope of the spirit of the invention, but this will also be said to be included within the scope of the present disclosure. In addition, elements having the same function within the scope of the invention shown in the drawings of each embodiment will be denoted by the same reference numerals even though they are depicted in different drawings.

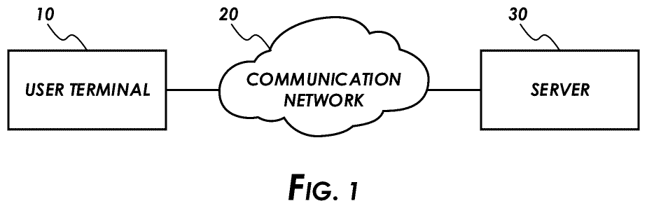

FIG. 1 is a block diagram for providing vacuum system design according to one embodiment of the present disclosure.

The vacuum system design according to one embodiment of the present disclosure may be performed by a “vacuum system design program”.

In one embodiment, the vacuum system design program may exist in a server 30 and be provided in a web-based form, and in this case, a user may design a vacuum system by accessing a website provided by the server 30 using a user terminal 10.

In another embodiment, the vacuum system design program may be installed in the user terminal 10 and the server 30 in a distributed manner, or may be installed independently in the user terminal 10 in a stand-alone form.

For example, parts of the vacuum system design program which use few resources, such as a user interface, may be provided in the user terminal 10, and parts of the vacuum system design program which use a lot of resources, such as a database, may exist in the server 30.

In yet another embodiment, all elements of the vacuum system design program including the database may exist in the user terminal 10.

In this case, the user terminal 10 does not need to be online for vacuum system design, and if necessary, the user terminal 10 may be physically connected to an external storage device in which an update file is stored so that the program may be updated.

Hereinafter, an embodiment in which the vacuum system design program exists in the server 30 and the vacuum system design described below is provided in a web-based form by the server 30 will be described.

For reference, the server 30 may include one or more processors and a memory connected to the processor, and program instructions, which are executable by the processor to perform operation of the server 30, which will be described below, may be stored in the memory.

In addition, the server 30 may further include a communication unit (not shown) configured to communicate with the user terminal 10.

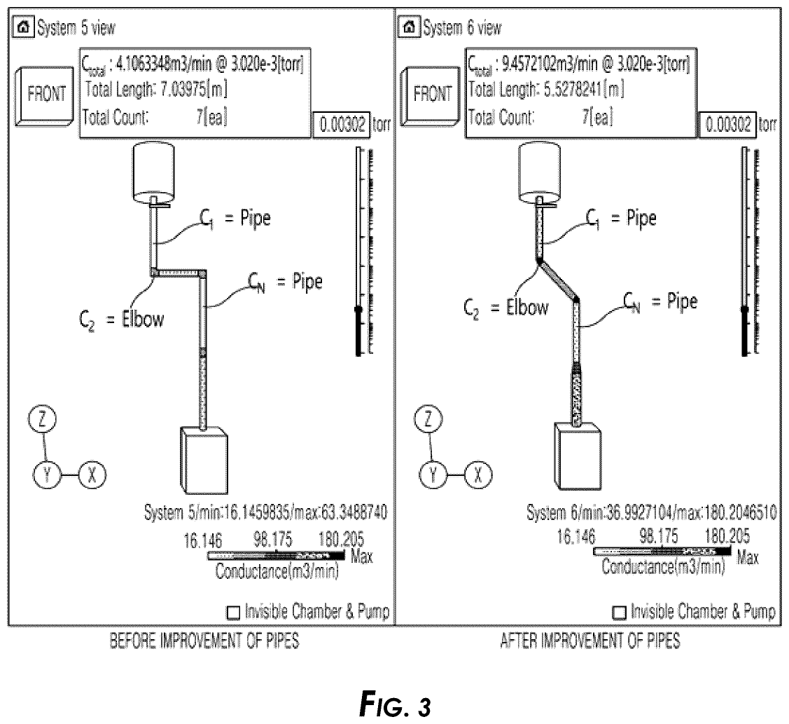

As one embodiment of the present disclosure, the server 30 may implement (design) the vacuum system by imaging and disposing elements, such as a chamber, piping, and a pump, in a 2D or 3D virtual area, and setting specifications of the respective elements, as shown in FIG. 3.

Here, in the case of the chamber, “specifications” may include a chamber shape (e.g., a rectangular parallelopiped, a cylinder, or the like), a volume, a start pressure, a target pressure, a gas load (or a gas flow), a process pressure, and the like. For reference, the “start pressure” and the “target pressure” may not be included in the specifications, but may be included in “process conditions” which will be described below.

In the case of the piping, the specifications may include types of pipes depending on the shapes of the pipes, such as pipes, bent pipes (bent/elbow/miter), and reduced pipes (reducers), the lengths, inner diameters, and angles of the pipes, and the like.

In the case of the pump, the specifications may include a pump size, the size and position of an inlet, a pumping speed, and the like.

The server 30 may simulate the vacuum system designed based on the above-described elements (the chamber, the piping, the pump, etc.) of the vacuum system, and may determine whether simulation results satisfy or dissatisfy the process conditions.

In the present disclosure, the “process conditions” may include first process conditions including the start pressure and target pressure of the chamber, and a time taken (which should be taken) from the start pressure to the target pressure of the chamber, and second process conditions including a process pressure at the maximum gas load or gas flow, a gas load at the maximum process pressure, and a gas load at the minimum process pressure. The first process conditions and the second process conditions may be set by a user.

The server 30 may provide related information so that a user may select a pipe having optimal specifications in the corresponding vacuum system by extracting a pipe having inefficient specifications among the respective component (the pipes, the bent pipes, the reduced pipes, etc.) of the entire piping implemented in the vacuum system using the vacuum system design program according to one embodiment of the present disclosure.

Here, “inefficient” may mean use of a pipe having low conductance even if the pipe satisfies the first and second process conditions.

Hereinafter, assuming that optimization of the specifications of other elements (the pump, the chamber, and the like) except the piping or optimization of the process conditions has been completed using the vacuum system design program according to one embodiment of the present disclosure, selection of a pipe having optimal specifications, i.e., selection of a pipe having optimized conductance, after completing optimization of other specifications, will be described.

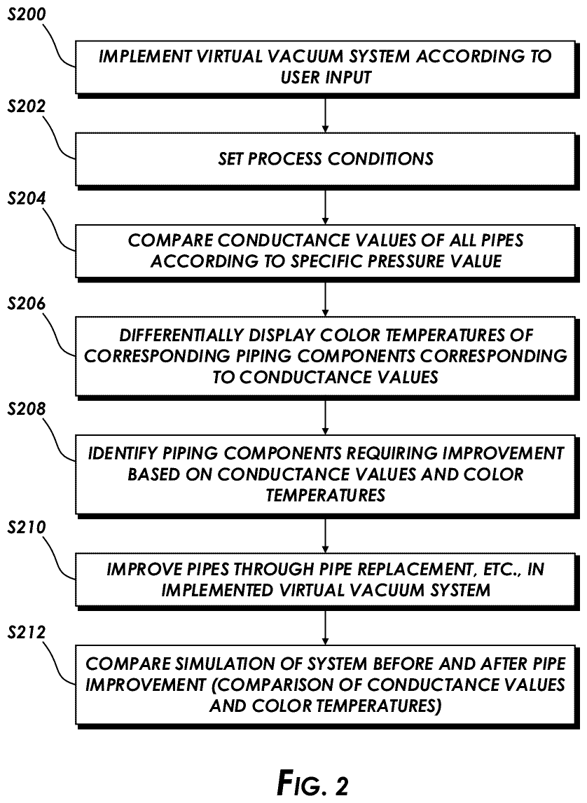

FIG. 2 is a flowchart showing a process of displaying and improving pipe conductances when designing the vacuum system according to one embodiment of the present disclosure, and this process may be performed by the server 30 shown in FIG. 1.

First, the server 30 implements the vacuum system by disposing the at least one chamber, piping, and pump in a virtual area according to user input (S200).

Here, the server 30 may implement the system by reflecting the specifications of each element input or selected by a user.

For reference, the user may select an icon provided in advance when selecting or input each element of the vacuum system and the specifications thereof, and may set the size or the position thereof by dragging a mouse. Of course, the user may also input figures directly.

Thereafter, the server 30 sets the first process conditions and the second process conditions of the vacuum system depending on user input (S202).

Here, the first process conditions may include the start pressure and target pressure of the chamber, and the time taken (which should be taken) from the start pressure to the target pressure of the chamber, and the second process conditions may include the process pressure at the maximum gas load or gas flow, the gas load at the maximum process pressure, and the gas load at the minimum process pressure.

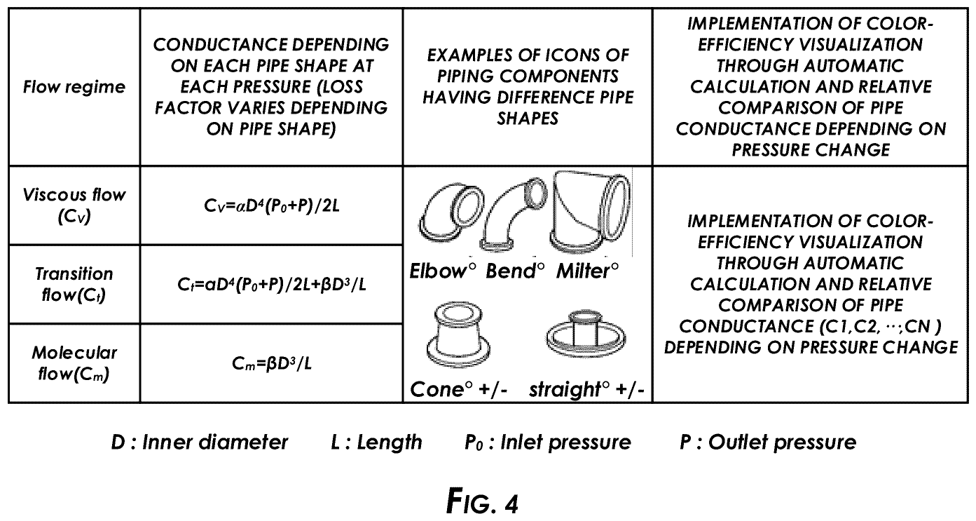

Here, in the case of pressure among the process conditions, the conductance value of a pipe may vary depending on a specific pressure value, and the pipe conductance at each pressure may be calculated by a pipe conductance calculation algorithm, as shown in FIG. 4. Further, the specific pressure value may be the process pressure at the maximum gas load or gas flow, which is one of the second process conditions, and in the present disclosure, when the process pressure is set to a specific value, the conductance values of the respective pipes may be calculated, the total pipe conductance value Cₜₒₜₐₗ=C₁+C₂+ . . . C_{N}, which is the sum of the conductance values C₁-C_{N} of the respective piping components, may be displayed numerically, and pipe efficiency evaluation depending on the conductance value of each piping components may be displayed as color temperatures set by relative comparison.

In addition, according to the pipe conductance calculation algorithm, a loss factor varies depending on the pipe shape or pressure and thus a conductance calculation equation may vary, and basically, the calculation equation includes the inner diameter and length of the pipe, the start pressure, and the ultimate pressure (target pressure) to calculate conductance (with reference to FIG. 4).

Further, the specific pressure value may be provided by disposing an adjustable interface on the program screen so that the user may arbitrarily specify the specific pressure value and compare the conductance values varying depending on a specific pressure change in real time, the interface may be provided in the form of a pressure adjustment bar to emphasize user convenience so that the specific pressure value may be easily adjusted, and the interface may be provided so that the user may directly input the specific pressure value manually through a keyboard or the like, if necessary.

The server 30 may calculate the conductance values of the respective piping components depending on the specific pressure input by the user, and may display the calculated conductance values on the screen for comparison thereamong (S204).

Here, the conductance value is an indicator of pipe efficiency, a higher conductance value may mean an improved pipe having better efficiency, and the server may display the preset color temperatures differently in response to the conductance values of the respective piping components (for example, pipes, bent pipes, reduced pipes, and the like, which are types of piping) calculated by the pipe conductance calculation algorithm depending on the specific pressure value, so that the user may easily identify the conductance values (S206).

The user in charge of vacuum system design may intuitively perform pipe efficiency evaluation by confirming the conductance values of the respective piping components depending on the specific pressure and the color temperatures displayed differently through relative comparison in response to the conductance values, displayed through the user terminal 10, and may thus easily confirm inefficient piping components (for example, red sections, etc.) (S208).

For example, the color temperatures for pipe conductance are provided to be gradually varied through relative comparison such that a section having relatively high conductance is set to blue, a section having medium conductance is set to green, and a section having relatively low conductance is set to red, so as to be easily confirmed visually.

Further, the color temperatures may be determined depending on the maximum and minimum conductance values set in advance by user settings, the maximum conductance value corresponds to a blue section, the minimum conductance value corresponds to a red section, and the color temperatures may be displayed differently to indicate pipe efficiency depending on the conductance values (values between the maximum conductance value and the minimum conductance value) of the piping components between the blue section and the red section.

Of course, the above settings for the color temperatures are just an arbitrary example and may be changed depending on user definition, and if necessary, the number of color temperatures, color types, etc. may be newly determined and displayed to better confirm the color temperature of each conductance value section precisely.

In addition, the user terminal 10 may allow the pipe specifications to be changed after confirming the color temperatures of the inefficient sections, thereby being capable of improving the conductances of the pipes.

Thereafter, the server 30 may compare respective vacuum systems designed with specifications before and after pipe improvement while fixing the elements and other specifications of the vacuum system (S210, S212).

Specifically, for example, the server 30 compares a first vacuum system, which is the vacuum system before improvement, and a second vacuum system, which is the vacuum system after improvement, displays the two vacuum systems on the screen, and in this case, results of the first and second vacuum systems including numerical display of the total conductance values of the pipings of respective systems depending on the specific pressure value, and pipe efficiency evaluation results indicating the conductance values of all the piping components used in the first and second vacuum systems displayed as color temperatures are displayed on one screen (S212).

As such, by easily confirming the total conductance values of the pipings and the color temperatures indicating the conductance values of the respective piping components before and after pipe improvement, it is possible to easily determine which part of the piping has poor conductance, and thereby, a guide may be provided at the time of design.

Further, if there is a plurality of piping components, the color temperatures of at least two piping components may be displayed differently depending on the conductance values of the respective piping components of the entire piping of the vacuum system under a specific pressure, and thereby, pipe efficiencies may be indicated depending on the color temperatures.

Further, when an interface is positioned on each piping component of the vacuum system by user action, a guide tip for improving pipe conductance in the corresponding section may be provided.

Here, positioning the interface by the user action may include, for example, positioning a mouse cursor or positioning a cursor to the corresponding section by keyboard action.

Further, the guide tip may be a guide tip that guides replacement of the corresponding pipe component, i.e., the corresponding pipe, to improve pipe conductance of the corresponding pipe component where the cursor is positioned, or may provide guidance on changing specification details, including changing the angle or inner diameter of the pipe, and it is possible to confirm whether the conductance has been changed through system implementation after improvement by replacing the pipe or changing the angle or inner diameter of the pipe depending on the corresponding guidance.

Furthermore, the server 30 may repeat the above-described steps depending on user input until the optimal specifications of the plural pipes are efficiently selected within a range within which the vacuum system designed by the user satisfies both the first process conditions and the second process conditions.

Here, the server 30 may display the total pipe conductance value depending on a pressure change, which is included in the process conditions, on the vacuum system implemented on the design program screen until an optimal vacuum system is designed, and in the process of implementing a new vacuum system by replacing a pipe(s) of the corresponding vacuum system with a substitute pipe by the user, may display the respective systems on one screen so that implementation results of the respective systems may be compared.

For example, the first and second vacuum systems before and after pipe improvement may be displayed on the screen so as to be compared with each other, and in this case, the display method may be implemented in the form of one window per system, so that a plurality of window screens may be displayed side by side on the screen, or may be displayed on the screen to overlap with (be stacked on) each other.

Further, a plurality of vacuum systems displayed on the screen may be displayed corresponding to the number of vacuum systems designed by the user in the program, and may be provided so that vacuum systems before and after pipe improvement may be compared and confirmed for each displayed system.

In addition, if improvement due to pipe replacement is performed plural times, all of simulation results before pipe improvement, and all of N simulation results from simulation results after 1^{st} pipe improvement to simulation results after N^{th} pipe improvement may be displayed so that the overall pipe conductance change trend may be confirmed.

For reference, before performing the above-described process, the user terminal 10 may attempt to log in to a website for vacuum system design, which is a web-based service provided by the server 30.

An initial membership registration process is required to verify login, and if a user proceeds as a non-member, the user may temporarily use the vacuum system program by verifying personal information, but benefits provided to members, such as discount benefits, may be limited.

For example, the server 30 may provide a vacuum system design program service to members only, and may provide a trial version and a full version through paid payments, and when using a full version service, payment may be made for each login, or a fixed-term payment method may be adopted.

Further, login authentication may be performed by matching personal information provided at the time of initial membership registration, and for this purpose, the server 30 may encrypt and store personal information in a database.

When login authentication has been completed, the web-based vacuum system design program is provided through a communication network 20, and for this purpose, the user terminal 10 must periodically access the server 30 through the communication network 20, and therefore, the user terminal 10 may have a built-in communication protocol which may be connected to the communication network 20.

In this specification, the “terminal” may be a wireless communication device which guarantees portability and mobility, and may be, for example, any type of handheld-based wireless communication device, such as a smartphone, a tablet PC, or a laptop. Further, the “terminal” may be a wired communication device, such as a PC which may be connected to another terminal or server through a communication network. In addition, the communication network indicates a connection structure which enables information exchange between nodes, such as terminals and servers, and includes a Local Area Network (LAN), a Wide Area Network (WAN), and the Internet (e.g., the World Wide Web (WWW)), a wired or wireless data communication network, a telephone network, a wired or wireless television communication network, or the like.

Examples of the wireless data communication network include 3G, 4G, 5G, 3rd Generation Partnership Project (3GPP), Long-Term Evolution (LTE), World Interoperability for Microwave Access (WIMAX), Wi-Fi, Bluetooth communication, infrared communication, ultrasonic communication, Visible Light Communication (VLC), LiFi, and the like, but are not limited thereto.

### DESCRIPTION OF REFERENCE NUMERALS AND MARKS

10: User terminal
20: Communication network
30: Server

1. A method of displaying pipe conductance in a vacuum system comprising at least one chamber, piping, and pump, implemented in a vacuum system design program of a server, the method comprising:
setting specifications of a chamber, piping, and a pump, and process conditions of a first vacuum system disposed in a virtual area, depending on user input;
displaying the first vacuum system on a screen based on the specifications of the chamber, the piping, and the pump, and the process conditions;
calculating a total conductance value of the piping depending on a specific pressure value among the process conditions and displaying the calculated total conductance value on the screen where the first vacuum system is implemented; and
displaying conductance values of respective piping components, preset depending on the specific pressure value, as color temperatures through relative comparison depending user settings.

2. The method according to claim 1, further comprising:
based on the first vacuum system designed to have specifications before pipe improvement and a second vacuum system designed to have specifications after pipe improvement, displaying, by the server, total conductance values of respective pipings of the first and second vacuum systems and color temperatures corresponding to conductance values of respective piping components of the first and second vacuum systems on a screen so as to be compared with each other.

3. The method according to claim 2, wherein results of the first and second vacuum systems comprising numerical display of the total conductance values of the pipings of the respective systems depending on the specific pressure value, and pipe efficiency evaluation results indicating the conductance values of all of the piping components used in the first and second vacuum systems as the color temperatures are displayed on one screen.

4. The method according to claim 3, wherein, if there is a plurality of piping components, color temperatures of at least two piping components are displayed differently through relative comparison depending on the conductance values of the respective piping components of the piping of the vacuum system under a specific pressure, and thereby, pipe efficiencies are indicated depending on the color temperatures.

5. The method according to claim 1, wherein, when an interface is positioned on each of the piping components of the vacuum system by user action, a guide tip configured to improve conductance of a corresponding one of the piping components is provided.

6. The method according to claim 5, wherein the guide tip guides replacement of the corresponding one of the piping components where a cursor is positioned to improve the conductance of the corresponding one of the piping components, or provides guidance on changing specification details, comprising changing an angle or inner diameter of the corresponding one of the piping components.

7. (canceled)

8. (canceled)

9. An apparatus for displaying pipe conductance in a vacuum system comprising at least one chamber, piping, and a pump, implemented in a vacuum system design program of a server, the apparatus comprising:
at least one processor; and
a memory connected to the at least one processor,
wherein the memory stores program instructions executable by the at least one processor to set specifications of a chamber, piping, and a pump, and process conditions of a first vacuum system disposed in a virtual area, depending on user input, to implement the first vacuum system on a screen based on the specifications of the chamber, the piping, and the pump, and the process conditions, to calculate a total conductance value of the piping depending on a specific pressure value among the process conditions and displaying the calculated total conductance value on the screen where the first vacuum system is implemented, and to display conductance values of respective piping components, preset depending on the specific pressure value, as color temperatures through relative comparison depending user settings.
